(19) United States
(12) Patent Application Publication
(10) Pub. No.: US 2005/0202802 A1
(43) Pub. Date: Sep. 15, 2005

(54) Mobile profile for application servers

(75) Inventors: Peeter Pruuden, Espoo (FI); Mikko Kolehmainen, Jarvenpaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/798,826

(22) Filed: Mar. 10, 2004

(51) Int. Cl. H04M 11/00

(52) U.S. Cl. 455/406; 455/411

(57) ABSTRACT

The invention provides a method and apparatus for identifying, compiling, deploying, managing, de-deploying, or some combination thereof, mobility components in a managed application server platform [e.g. J2EE environment] by instantiating a mobility profile in the application server for making common mobile functionality available to mobility specific components. The result of applying this method is an instance of mobility profile that allows applying mobility specific functionalities in the server side with a similar manner that has been provided with other managed containers. The invention builds on an observation that mobility specific capabilities share some common functionality and then some component specific added value functionalities.

### BACKGROUND OF THE INVENTION

1. Field of Invention

The present invention relates to a method and apparatus for providing a mobility profile for application servers, especially in third generation partnership project (3GPP) wireless network.

2. Description of Related Art

In the prior art, the Java 2 Enterprise Edition (also known as “J2EE”) architecture specifies four kinds of containers: Enterprise JavaBeans (EJB) container, Web container, Application Client container, and Applet container. Containers are the interface between a component and the low-level platform specific functionality that supports the component. Before a Web, enterprise bean, or application client component can be executed, it must be assembled into a J2EE application and deployed into its container.

The assembly process involves specifying container settings for each component in the J2EE application and for the J2EE application itself. The container settings customize the underlying support provided by the J2EE server, which includes services such as security, transaction management, Java Naming and Directory Interface™ (JNDI) lookups, and remote connectivity. The container also manages nonconfigurable services such as enterprise bean and servlet life cycles, database connection resource pooling, data persistence, and access to the J2EE platform application program interfaces (APIs).

In the J2EE architecture, a container serves as an authorization boundary between the components it hosts and their callers. The authorization boundary exists inside the container's authentication boundary so that authorization is considered in the context of successful authentication. For inbound calls, the container compares security attributes from the caller's credentials with the access control rules for a target component. If the rules are satisfied, the call is allowed; otherwise, the call is rejected.

The container runtime provides the deployed enterprise beans with transaction and security management, network distribution of remote clients, scalable management of resources, and other services that are generally required as part of a manageable server platform.

Each of the four types of containers provide a specific set of services to the components they to host. The type of component specifies which container should be used.

One problem in the art is that J2EE architecture does not currently have specific support for mobility components such as Presence, Location, Instant Messaging etc. Such mobility components all require an additional set of functionality that is currently not provided by existing containers. Typically, the J2EE mobility profile is used with additional libraries that are specifically needed to be deployed for deploying also mobility components.

In the prior art, the above-mentioned libraries can be specifically built and even standardized (although currently they are not), but a complete set of such required functionalities is not specified in the known standards. But they are still all required for the mobility components in most cases. So in order to develop and deploy such a mobility component, the developer must specifically make sure the supporting components get deployed on the system too. However, there is still no guarantee that once the component is eventually deployed in another system, the required components are deployed there as well, since the specification for the set of required functionalities is missing.

In view of this, there is a need in the prior art for a solution to this problem, and the invention shown and described herein provides such a solution.

### SUMMARY OF INVENTION

In its broadest sense, the present invention provides a new and unique method and apparatus for identifying, compiling, deploying, managing, de-deploying, or some combination thereof, mobility components in a managed application server platform (e.g. J2EE environment), featuring the step of instantiating a mobility profile in an application server execution environment for making common mobile functionality available to mobility specific components.

The result of applying this method is an instance of “mobility profile” that allows applying mobility specific functionalities in the server side with a similar manner that has been provided with other managed containers. The invention builds on an observation that mobility specific capabilities share some common functionality and then some component specific added value functionalities. These mobility profile specific functions include, but not limited to, the following:

Accounting Charging,

Subscriber Management,

Authentication,

Identity Management,

Authorization Policy Management,

Device Profile Management,

Session & Transaction Management,

Service Registry, and/or

Workflow management.

The mobility profile can be instantiated on top of an existing container, or be implemented as an independent container, as well as one that is already running. In the former case, it would be mediating the underlying services of the container via existing or well-defined non-fragmented call interfaces. An example of this is to instantiate the mobility profile to a J2EE EJB container in a manner that then makes it possible to provide mobility profile contracts to the components utilizing the available functionalities without being tied to the underlying network structure and variances within the underlying network protocols that are used for providing services to the mobility container. The implementation of mobility profile may utilize the capabilities of existing, or underlying containers. If a mobility profile is instantiated a separate container, this allows fine-tuning of the mobility specific capabilities with respect to existing resources. This might be beneficial e.g. in embedded implementations.

The main advantage of the invention is the abstraction of functionality provided by the mobility profile in a manner that creates a separation of the application utilizing the added value services and the instantiation of the environment. In addition, when there exists the mobility profile, all applications can perform their mobility related tasks in a similar manner, i.e. a service operator can count on the behavior provided by the mobility profile being consistent, regardless of origin.

Other advantages include the fact that packetizing several functionalities within the profile behind single deployment descriptor makes it easier to manage the interdependencies between such functionalities. In addition, functional requirements for mobile enhancements in application server can be described more easier, and thus minimize the risk of down-time due to inappropriate service management and operation by operative personnel.

The implementation of the present invention would specify the functionalities available as a packaged profile for mobility components that are not available in J2EE 1.4 EJB container specification, which may be available as a separate optional package that is implemented where needed in existing installations.

Some of the common functions can technically already be supported by EJB container, such as JAAS for authentication and authorization, etc., but the EJB container specifies only the technologies that can be used for this purpose. The schemas required for using JAAS for authenticating and authorizing the users of mobility components are not covered by these specifications. Therefore, technologies available in J2EE 1.4 specification should only be used when bundled together with such schemas. In practice, the mobility profile implementation can build on the approach chosen in JSR-212 specification, and then extend it to cover provisioning of all required functionalities.

### BRIEF DESCRIPTION OF THE DRAWING

The drawing, not drawn to scale, includes the following Figures:

FIG. 1 is a diagram of a network according to the present invention.

FIG. 2 is a diagram of the J2EE container architecture approach according to the present invention.

### DETAILED DESCRIPTION OF INVENTION

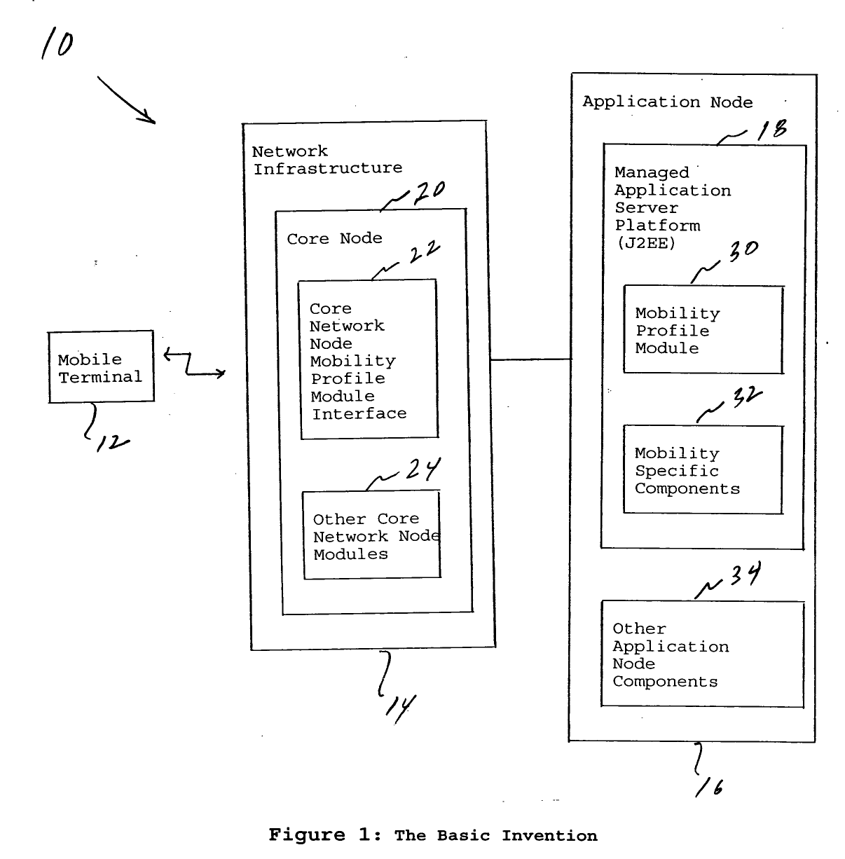

### FIG. 1

FIG. 1 shows the basic invention in the form of a network, such as a wireless network generally indicated as 10, including a mobile terminal 12, a network infrastructure 14, coupled to an application node 16, which is shown and described herein by way of example as a managed application server platform (J2EE) 18.

The network infrastructure 14 includes among other elements a core network node 20 having a mobility profile module interface 22 and other known core network node modules 24.

In the applications node 16, the managed application server platform (J2EE) 18 includes a mobility profile module 30, mobility specific components 32 and other application node components 34. In accordance with the invention, a method is specified for identifying, compiling, deploying, managing, de-deploying, or some combination thereof, mobility specific components 32 in the managed application server platform (J2EE) 18. In order to do so according to the present invention, the mobility profile module 30 in the application node 16 instantiates a mobility profile in an application server execution environment for making common mobile functionality available to the mobility specific components 32.

According to the invention, the mobility profile allows applying mobility specific functionalities in the server side in a similar manner that has been provided with other managed containers. The mobility specific functions include either accounting charging, subscriber management, authentication, identity management, authorization policy management, device profile management, session & transaction management, service registry, workflow management, or some combination thereof.

The mobility profile module 30 may either instantiate the mobility profile on top of an existing container, or may implement the mobility profile as an independent container. The mobility profile module 30 may also instantiate the mobility profile to a given container in a manner that then makes it possible to provide mobility profile contracts to the components utilizing available functionalities. The mobility profile module 30 may also instantiate the mobility profile in a separate container to allow fine-tuning of the mobility specific capabilities with respect to existing resources. The mobility profile module 30 may implement the functionalities available as a packaged profile for mobility components that are not available in a given container specification.

The mobile profile module 30 may be implemented using hardware, software, or a combination thereof. In a typical software implementation, the mobile profile module 30 would be a microprocessor-based architecture having a microprocessor, a random access memory (RAM), a read only memory (ROM), input/output devices and control, data and address buses connecting the same. A person skilled in the art would be able to program such a microprocessor-based implementation to perform the functionality described herein without undue experimentation.

The invention is shown and described herein by way of example in relation to the J2EE managed application server platform; however, the scope of the invention is intended to include instantiating such a mobility profile in another application server execution environment either now known or later developed in the future for making common mobile functionality available to the mobility specific components.

### The Mobile Terminal 12

The mobile terminal 12 may be in the form of a mobile phone or other user equipment that is known in the art. In operation, the mobile terminal communicates via the network infrastructure 14 to either send or receive data to or from the application node 16 using the managed application server platform (J2EE) 18. The scope of the invention is not intended to be limited to any particular mobile phone or terminal either now known or later developed in the future.

### The Mobility Profile Module Interface 22

The mobility profile module interface 22 forms part of the core network 20 and provides interface functionality, if any is necessary, between the core node 20 of the network infrastructure 14 and the managed application server platform (J2EE) 18 of the application node 16. The mobility profile module interface 22 may be implemented using hardware, software, or a combination thereof, consistent with that described herein. The scope of the invention is also intended to include implementing in the mobility profile module interface 22 at least some part of the instantiating of the mobility profile functionality in cooperation with the mobility profile module 30.

### The Other Modules and Components

The other core node modules 24, as well as the other application node components 34, including those for providing application specific content, etc., are all well known in the art and do not form part of the present invention.

### The Term “Instantiation”

It is understood that the term “instantiation” is a term used in art of computer programming and understood to mean the process of substituting specific data, instructions, or both into a generic program unit to make it usable in a computer program, although the scope of the invention is intended to be limited to the same.

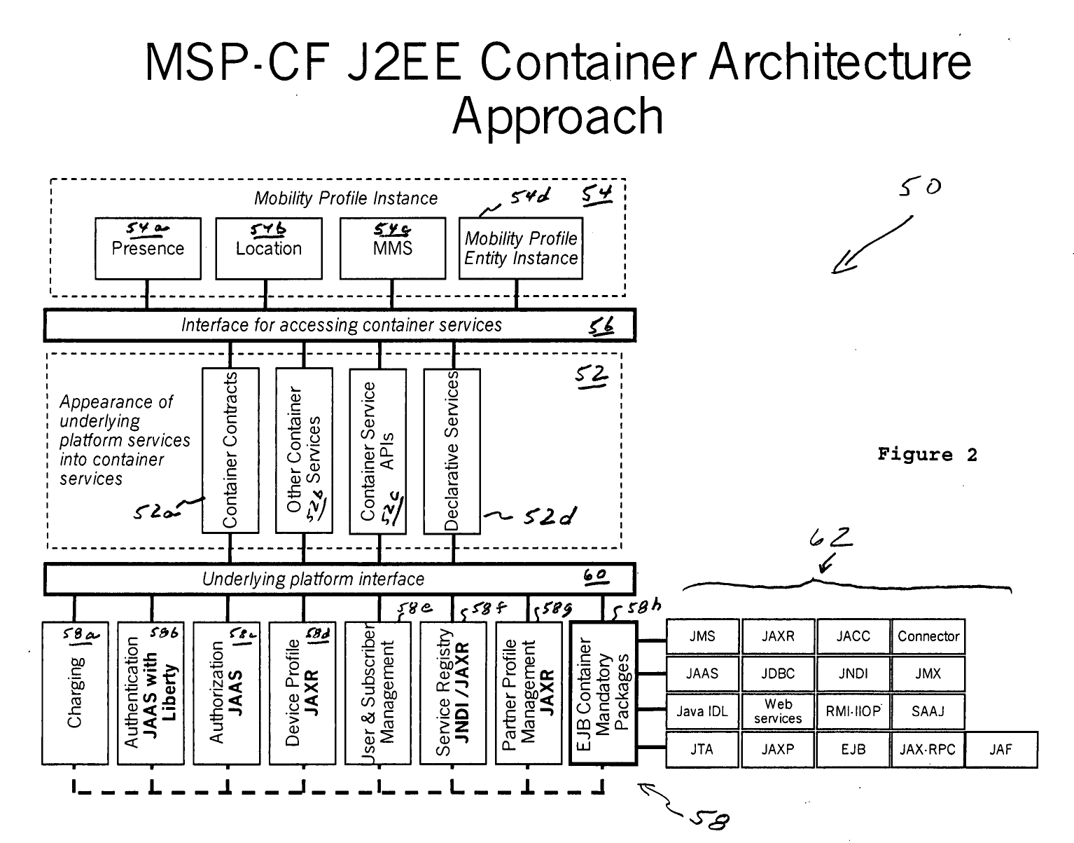

### FIG. 2: J2EE Container Architecture Approach

By way of example, FIG. 2 shows an embodiment of a J2EE container architecture approach generally indicated as 50 that includes a module 52 for the appearance of underlying platform services into container services that is coupled to a module 54 for a mobility profile instance via an interface module 56 for accessing container services. The module 52 for the appearance of underlying platform services into container services includes a module 52a for container contracts, a module 52b for other container services, a module 52c for container service APIs and a module 52d for declarative services. In operation, a container serves as an authorization boundary between components it hosts and their callers. It thus implements policy enforcement. The container contract(s) is a set of APIs specified by the container that your application components are required to extend or implement. The other container services are related to component lifestyle, resource pooling, garbage collection, etc. The declarative services are services that the container interposes on your applications based on the deployment description provided for each application component.

The module 54 for a mobility profile instance includes a module 54a for the presence, a module 54b for the location, a module 65c for the MMS and a module 54d for the mobility profile entity instance.

The module 52 for the appearance of underlying platform services into container services is also coupled to various modules generally indicated as 58 for the underlying platform via a module 60 for an underlying platform interface. The various modules 58 include a module 58a for charging, a module 58b for authentication JAAS with liberty, a module 58c for authorization with JAAS, a module 58d for the device profile JAXR, a module 58e for the user and subscriber management, a module 58f for the service registry JNDI/JAXR, a module 58g for the partner profile management JAXR and a module 58h for EJB container mandatory packages.

The module 58h for EJB container mandatory packages is coupled to modules for functionality generally indicated as 62, including, but not limited to, either JMS, JAAS, Java IDL, JTA, JAXR, JDBC, web services, JAXP, JACC, JNDI, RMI-llOP, EJB, connector, JMX, SAAJ, JAX-RPC, JAF or any combination thereof.

The modules in the J2EE container architecture 50 may be implemented using hardware, software, or a combination thereof, consistent with that described herein, and the scope of the invention is not intended to be limited to any particular implementation thereof. A person skilled in the art would be able to implement the same after reading the specification in conjunction with the drawing.

### Computer Program and Products

The present invention also includes implementing the step of the method via a computer program running in a processing means in a mobility profile module or other suitable module, as well as including a computer program product with a program code, which program code is stored on a machine readable carrier, when the computer program is run in a suitable processing means in the mobility profile module or other suitable module.

### Scope of the Invention

The scope of the invention is not intended to be limited to any specific kind of network architecture, application node, user equipment, mobile terminal, phone or device, and many different mobile terminals or device, including laptop or notebook computers, are envisioned that may contain the fundamental features of the present invention described herein.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method for identifying, compiling, deploying, managing, de-deploying, or some combination thereof, mobility components in a managed application server platform of a network, characterized in that the method comprises the step of:
instantiating a mobility profile in an application server execution environment for making common mobile functionality available to mobility specific components.

2. A method according to claim 1, wherein the mobility profile allows applying mobility specific functionalities in a server side in a similar manner that has been provided with other managed containers.

3. A method according to claim 1, wherein mobility specific functions include either accounting charging, subscriber management, authentication, identity management, authorization policy management, device profile management, session & transaction management, service registry, workflow management, or some combination thereof.

4. A method according to claim 1, wherein the mobility profile is either instantiated on top of an existing container, or implemented as an independent container.

5. A method according to claim 1, wherein the method includes the step of instantiating the mobility profile to a given container in a manner that then makes it possible to provide mobility profile contracts to the components utilizing available functionalities.

6. A method according to claim 1, wherein the method includes the step of instantiating the mobility profile in a separate container to allow fine-tuning of the mobility specific capabilities with respect to existing resources.

7. A method according to claim 1, wherein the method includes the step of implementing the functionalities available as a packaged profile for mobility components that are not available in a given container specification.

8. A method according to claim 1, wherein the method includes the step of implementing the instantiating of the mobility profile in a mobility profile module in an application node.

9. A method according to claim 1, wherein the method includes the step of implementing the instantiating of the mobility profile in either a mobility profile module in an application node, a mobility profile module interface in a core network, or some combination thereof.

10. A node for identifying, compiling, deploying, managing, de-deploying, or some combination thereof, mobility components in a managed application server platform of a network, characterized in that the node instantiates a mobility profile in an application server execution environment for making common mobile functionality available to mobility specific components.

11. A node according to claim 10, wherein the mobility profile allows applying mobility specific functionalities in a server side in a similar manner that has been provided with other managed containers.

12. A node according to claim 10, wherein mobility specific functions include either accounting charging, subscriber management, authentication, identity management, authorization policy management, device profile management, session & transaction management, service registry, workflow management, or some combination thereof.

13. A node according to claim 10, wherein the mobility profile is either instantiated on top of an existing container, or implemented as an independent container.

14. A node according to claim 10, wherein the node instantiates the mobility profile to a given container in a manner that then makes it possible to provide mobility profile contracts to the components utilizing available functionalities.

15. A node according to claim 10, wherein the node instantiates the mobility profile in a separate container to allow fine-tuning of the mobility specific capabilities with respect to existing resources.

16. A node according to claim 10, wherein the node implements the functionalities available as a packaged profile for mobility components that are not available in a given container specification.

17. A node according to claim 10, wherein the node includes a mobility profile module for instantiating the mobility profile.

18. A node according to claim 10, wherein the node forms part of an application node.

19. A method according to claim 10, wherein the node forms part of an application node, a core network, or some combination thereof.

20. A method according to claim 1, wherein the method further comprises implementing the step of the method via a computer program running in a processing means in a mobility profile module or other suitable module.

21. A computer program product with a program code, which program code is stored on a machine readable carrier, for carrying out the steps according to claim 1 when the computer program is run in a processing means in a mobility profile module or other suitable module.
